(19) United States
(12) Patent Application Publication
(10) Pub. No.: US 2019/0054586 A1
(43) Pub. Date: Feb. 21, 2019

(54) DRIVING SHAFT FOR MACHINE

(71) Applicant: TAIWAN RONG FU INDUSTRIAL CO., LTD., TAICHUNG (TW)

(72) Inventor: LIN BIN CHUN, TAICHUNG (TW)

(21) Appl. No.: 15/783,070

(22) Filed: Oct. 13, 2017

(30) Foreign Application Priority Data
Aug. 18, 2017 (TW) 106212237

(51) Int. Cl. B23Q 5/04

(52) U.S. Cl. CPC B23Q 5/04

(57) ABSTRACT

A driving shaft is a hollow or solid shaft with multiple sections of different diameters, and the shaft includes a transmission end and a knife end. The transmission end is formed on a first-diameter section of the shaft. The transmission end has a first shoulder to which a bearing is mounted. At least one transmission member is connected to the transmission end. The knife end is formed on a second-diameter section of the shaft and has a second shoulder to which another bearing is mounted. A knife is connected to the knife end. The knife end includes a release hole and a tapered hole. At least two grooves are defined in the transmission end and extend toward the knife end for a length. Higher torque is able to be applied to the shaft.

### BACKGROUND OF THE INVENTION

### 1. Fields of the Invention

The present invention relates to a driving shaft, and more particularly, to a driving shaft for a machine such as milling machine.

### 2. Descriptions of Related Art

The transmission system for conventional drilling machine or milling machine generally includes motor-gear type and motor-belt wheel type. The conventional driving shaft “B” is driven by the transmission system is disclosed in FIG. 9 and includes multiple different outer diameters sections. The driving shaft “B” includes shaft 9 with a knife end 91 and a driving end 92. A center hole 90 is defined through the driving shaft “B”. A tapered hole 911 and a release hole 912 are defined in the knife end 91. The knife 93 is secured in the tapered hole 911, and can be replaced by inserting a wedge plate 94 into the release hole 912 to release the knife 93 from the tapered hole 911.

The driving end 92 is a castellated shaft 921 which includes multiple flutes 922 defined evenly therein. The flutes 922 have a fixed length and located next to one of two shoulders 901 of the driving shaft “B”. Two bearings are mounted to the two shoulders 901 so that the driving shaft “B” is rotatable. A transmission member 95 is mounted to the castellated shaft 921 and stopped by the shoulder 901. The transmission member 95 includes a mounting hole 951, as shown in FIG. 10, so as to be connected with the flutes 921. The power source provides power to the transmission member 95 which rotates the driving shaft “B”, and the knife 93 is driven to drill or mill objects.

The shapes of the castellated shaft 921 and the mounting hole 951 are complicated and difficult to be machined. Stress concentration happened at the area as marked by “b” of the flutes 922 and the mounting hole 951, so that the torque transferred to the shaft 9. Furthermore, after a period of time of use, the a gap “c” between the flutes 922 and the mounting hole 951 increases due to friction and wearing, and the gap causes noise.

The present invention intends to provide a driving shaft that eliminates the shortcomings mentioned above.

### SUMMARY OF THE INVENTION

The present invention relates to a driving shaft which is a shaft with multiple sections of different diameters. The shaft is a hollow shaft or a solid shaft, and comprises a transmission end and a knife end respectively formed on two ends of the shaft. The transmission end is formed on a first-diameter section of the shaft, and the first-dimeter section has a first radius. The transmission end has a first shoulder to which a bearing is mounted. At least one transmission member is connected to the transmission end. The knife end is formed on a second-diameter section of the shaft and has a second shoulder to which another bearing is mounted. A knife is connected to the knife end. The knife end has a release hole and a tapered hole. At least two grooves is defined in the transmission end and extends toward the knife end for a length. The first shoulder is located at two respective lower ends of the grooves, and each of the grooves has a second radius which is smaller than the first radius.

Preferably, the first radius is two to five times of the second radius.

Preferably, each of the grooves has the depth which is 1/13 to ⅕ of the outer diameter of the first-diameter section.

Preferably, the length of each groove is less than one half of the total length of the shaft.

Preferably, a keystone slot is defined in the end face of the knife end so as be connected with a key on a milling knife.

Preferably, the transmission member is a gear and the mounting hole of the transmission member is shaped to be connected with the grooves.

Preferably, the transmission member includes a stepped belt wheel and a sleeve which is shaped to be engaged with the grooves. The sleeve has a tapered outside. The stepped belt wheel is mounted to the tapered outside of the sleeve.

Preferably, the shaft has a center hole which includes multiple inner diameters.

Preferably, the shaft is used on a drilling machine with belt wheel transmission system or on a drilling machine with gear transmission system. The knife is a drilling knife or a milling knife.

The advantages of the present invention are that the driving shaft for a drilling machine or a milling machine includes two grooves defined in the driving end, and the two grooves reduce the manufacturing complicities when manufacturing the driving shaft.

There is no stress concentration to the shaft due to the grooves. The cross sectional area of the shaft with the two grooves of the present invention is more than 11% of the conventional shaft of the same diameter. The torque that the shaft transfers is increased 10% to 30% compared with the conventional shaft.

The two grooves of the shaft are easily cooperated with the transmission member so as to reduce noise up to 6 dB to 10 dB.

The shaft is shaped by a special way so that the parts can be used on different machine, such as drilling machine, milling machine or compound drilling-milling machine.

The present invention will become more apparent from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the driving shaft of the present invention;

FIG. 2 is a cross sectional view to show the driving shaft of the present invention, wherein the driving shaft is a solid shaft;

FIG. 3 is a cross sectional view to show the driving shaft of the present invention, wherein the driving shaft is a hollow shaft;

FIG. 4 is a cross sectional view, taken along line a-a in FIG. 2;

FIG. 5 is a partial cross sectional view to show that the driving shaft of the present invention is used on a gear-driving drilling machine;

FIG. 6 is a partial cross sectional view to show that the driving shaft of the present invention is used on a belt wheel-driving drilling machine;

FIG. 7 is a perspective view to show that the driving shaft of the present invention is used on a gear-driving drilling machine;

FIG. 8 is a perspective view to show that the driving shaft of the present invention is used on a belt wheel-driving drilling machine;

FIG. 9 is a cross sectional view to show the conventional driving shaft, and

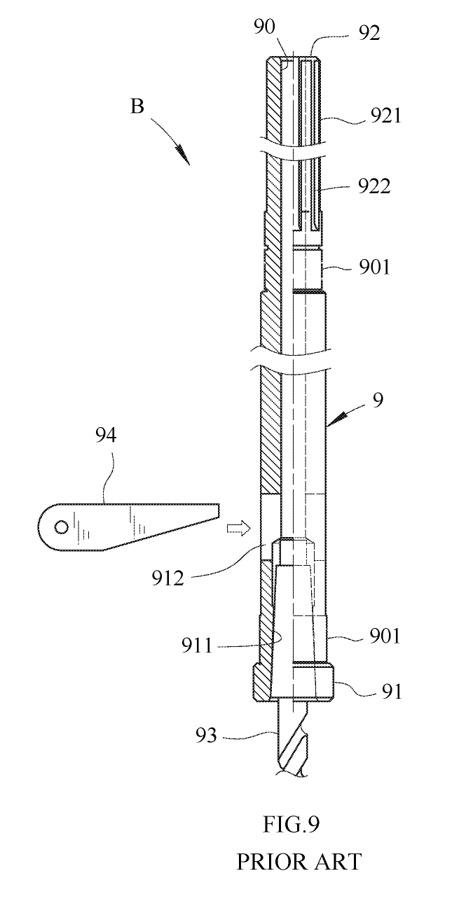

FIG. 10 is a cross sectional view to show that a transmission member is connected to the conventional driving shaft.

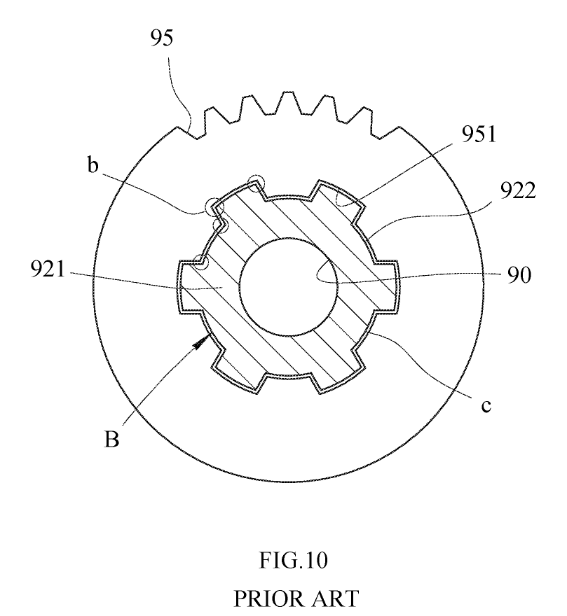

### DETAILED DESCRIPTION OF THE PREFERRED EMBODIMENT

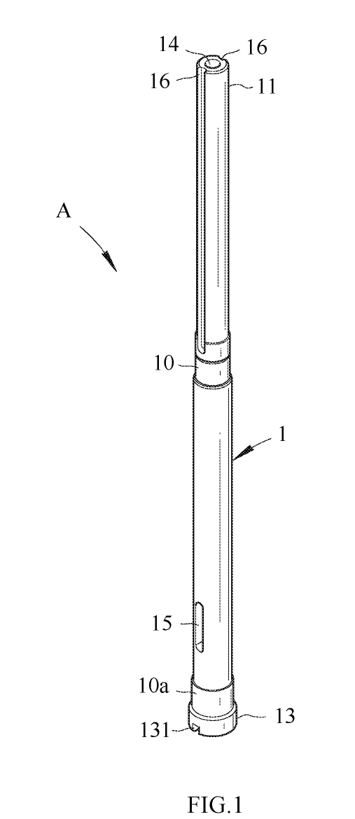

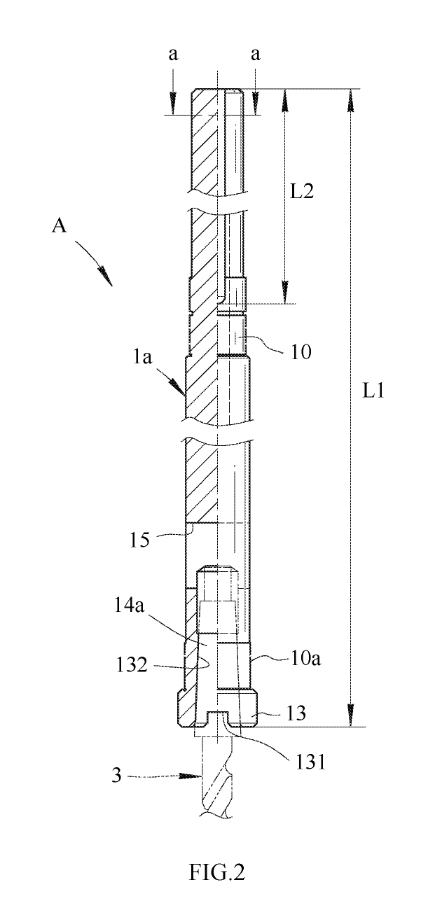

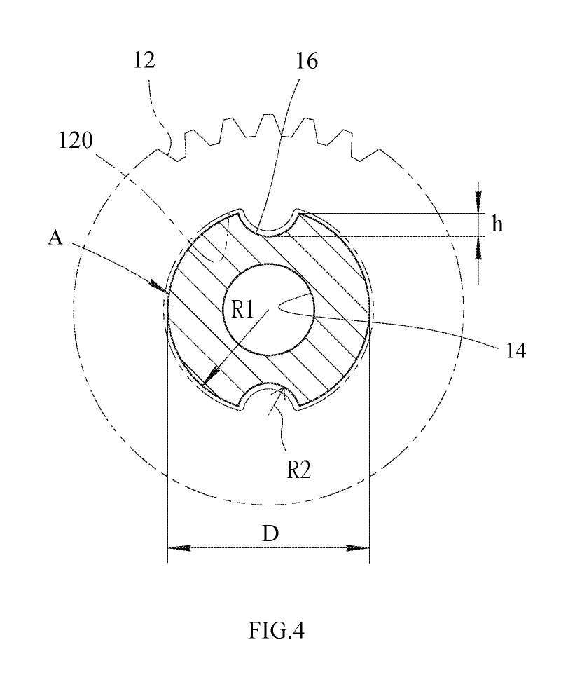

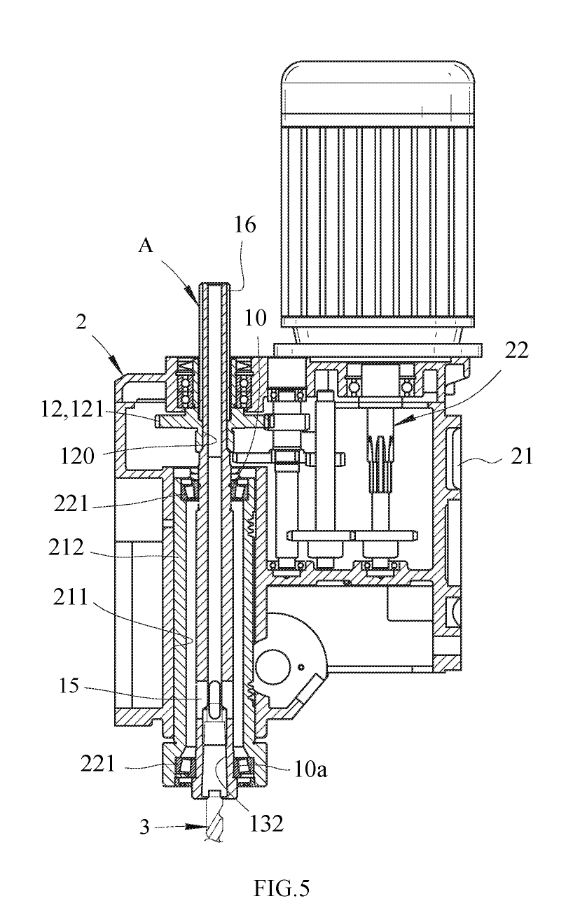

Referring to FIGS. 1 to 5, the driving shaft “A” which is a shaft 1 with multiple sections of different diameters. The shaft 1 is a hollow shaft or a solid shaft, and comprises a transmission end 11 and a knife end 13 respectively formed on two ends of the shaft 1. The transmission end 11 is formed on a first-diameter section of the shaft 1, and the first-dimeter section has a first radius “R1” as shown in FIG. 4. The transmission end 11 has a first shoulder 10 to which a bearing 221 is mounted as shown in FIG. 5. At least one transmission member 12 is connected to the transmission end 11. The knife end 13 is formed on a second-diameter section of the shaft 1 and has a second shoulder 10a to which another bearing 221 is mounted. A knife 3 is connected to the knife end 13. The knife end 13 has a release hole 15 and a tapered hole 132. The shaft 1/1a has a center hole 14 including multiple inner diameters, or a tapered center hole 14a as shown in FIG. 2. The center hole 14 and the tapered center hole 14a communicates with the release hole 15. At least two grooves 16 are defined in the transmission end 11 and extends toward the knife end 13 for a length “L2”. The first shoulder 10 is located at two respective lower ends of the grooves 16, and each of the grooves 16 has a second radius “R2” which is smaller than the first radius “R1”. Preferably, the first radius “R1” is two to five times of the second radius “R2”. As shown in FIG. 2, the solid shaft la has the tapered center hole 14a is used on drilling machine, so that the knife 3 is a drilling knife which his engaged with the tapered center hole 14a, and released from the tapered center hole 14a by inserting a wedge plate 94 into the release hole 15.

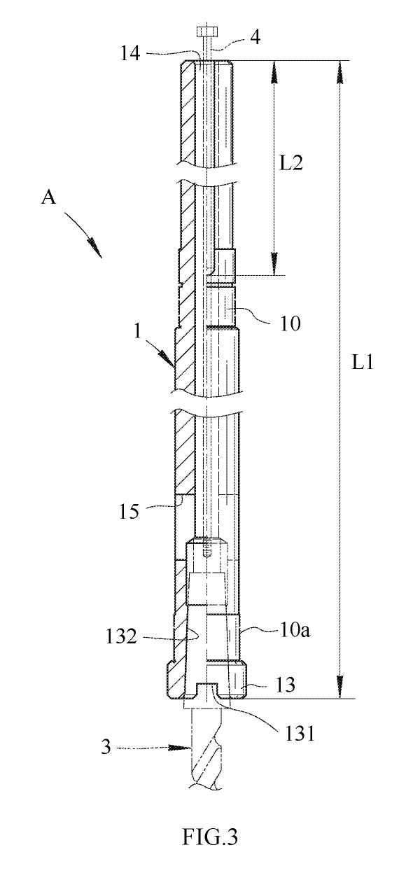

As shown in FIG. 3, the hollow shaft 1 has the center hole 14 is used on a milling machine or a compound drilling-milling machine. A locking member 4 is inserted into the center hole 14 and is threadedly connected to a threaded hole in the top of the knife 3. The knife 3 is a milling knife, a drilling knife or other knife. The knife 3 is released from the center hole 14 by inserting a wedge plate 94 into the release hole 15. As shown in FIG. 4, each of the grooves 16 has the depth “h” which is 1/13 to ⅕ of the outer diameter “D” of the first-diameter section. The length “L2” of each groove 16 is less than one half of the total length “L 1” of the shaft 1. A keystone slot 131 is defined in the end face of the knife end 13 so as be connected with a key on a milling knife.

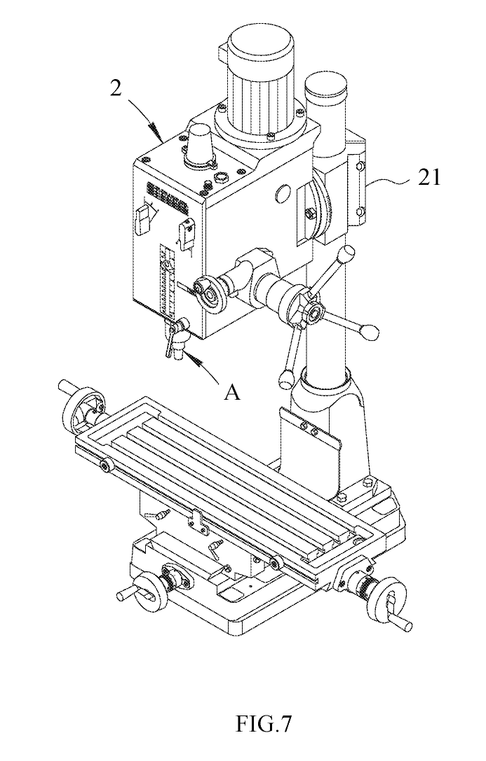

When the driving shaft “A” is used on a gear-driving drilling machine 2, as shown in FIGS. 4, 5 and 7, the shaft 1 is inserted into a sleeve 212 in the passage 211 of the body 21. There are two bearings 221 on the two shoulders 10, 10a, and the transmission member 12 is mounted to the driving end 11 to be engaged with the two grooves 16. The transmission member 12 is a gear 121 and the mounting hole 120 of the transmission member 12 is shaped to be connected with the grooves 16. The transmission system 22 drives the gear and the shaft 1 to rotate, and the knife 3 is rotated and moves with the sleeve 212 to drill objects.

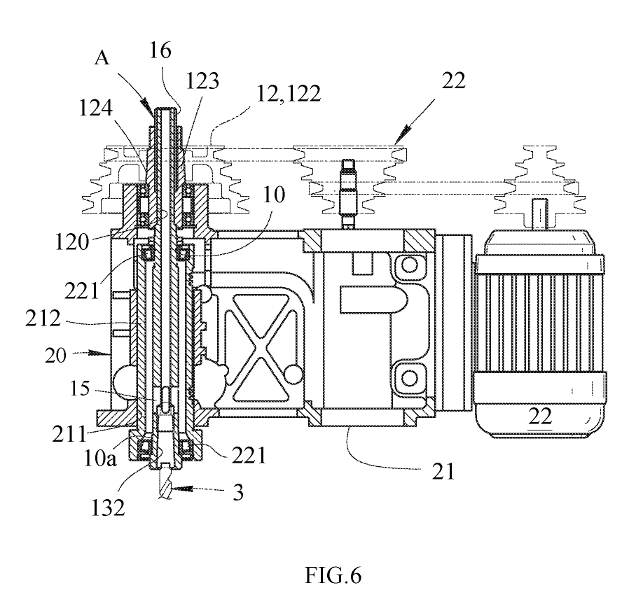

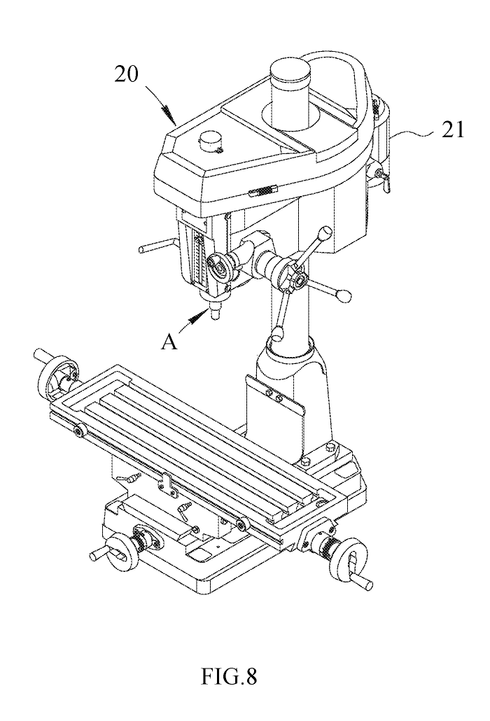

When the driving shaft “A” is used on a belt wheel-driving drilling machine 20, as shown in FIGS. 6 and 8, the shaft 1 is inserted into a sleeve 212 in the passage 211 of the body 21. There are two bearings 221 on the two shoulders 10, 10a, and the transmission member 12 is mounted to the driving end 11 to be engaged with the two grooves 16. The transmission member 12 includes a stepped belt wheel 122 and a sleeve 123 which has a mounting hole 120 which is shaped to be engaged with the grooves 16. The belt wheel 122 is mounted to the tapered outside 124 of the sleeve 123. The transmission system 22 drives the belt wheel 122 and the shaft 1 to rotate, and the knife 3 is rotated and moves with the sleeve 212 to drill objects.

While we have shown and described the embodiment in accordance with the present invention, it should be clear to those skilled in the art that further embodiments may be made without departing from the scope of the present invention.

1. A driving shaft apparatus comprising:
a shaft with multiple sections of different diameters extending from a transmission end to a knife end directly holding a knife, the transmission end formed on a first-diameter section of the shaft, the first-diameter section having a first radius, the transmission end having a first shoulder to which a bearing is mounted, the shaft being rotationally driven by at least one transmission member surrounding and connected to an external surface of the transmission end;
the knife end formed on a second-diameter section of the shaft, the knife end having a second shoulder to which another bearing is mounted, the knife connected to the knife end, the knife end having a release hole and a tapered hole, and
at least two grooves defined in the external surface of the transmission end and extending toward the knife end for a length, the first shoulder located at two respective lower ends of the grooves, each of the grooves having a second radius which is smaller than the first radius.

2. The driving apparatus as claimed in claim 1, wherein the first radius is two to five times of the second radius.

3. The driving apparatus as claimed in claim 1, wherein each of the grooves has a depth which is 1/13 to ⅕ of an outer diameter of the first-diameter section.

4. The driving apparatus as claimed in claim 1, wherein the length of each groove is less than one half of a length of the shaft.

5. The driving apparatus as claimed in claim 1, wherein a keystone slot is defined in an end face of the knife end to be connected with a key on a milling knife.

6. The driving apparatus as claimed in claim 1, wherein the transmission member is a gear and the mounting hole of the transmission member is shaped to be connected with the grooves.

7. The driving apparatus as claimed in claim 1, wherein the transmission member includes a stepped belt wheel and a sleeve which is shaped to be engaged with the grooves, sleeve has a tapered outside, the stepped belt wheel is mounted to the tapered outside of the sleeve.

8. The driving shaft as claimed in claim 1, wherein the shaft is used on one of a drilling or milling machine with belt wheel transmission system or a drilling or milling machine with gear transmission system, and the knife is selected from the group consisting of: a drilling knife or a milling knife.

9. The driving apparatus as claimed in claim 1, wherein the first-diameter section is formed with a hollow configuration.

10. The driving apparatus as claimed in claim 1, wherein the first-diameter section is formed with a solid configuration.

11. The driving apparatus as claimed in claim 1, wherein at least a portion of the second-diameter section is formed with a solid configuration.
